(19) United States
(12) Patent Application Publication
(10) Pub. No.: US 2011/0262877 A1
(43) Pub. Date: Oct. 27, 2011

(54) HEAT TREATMENT APPARATUS

(76) Inventor: Kazuhiko Katsumata, Tokyo (JP)

(21) Appl. No.: 13/003,031

(22) PCT Filed: Jul. 10, 2009
(86) PCT No.: PCT/JP2009/062617

§ 371 Date: Jan. 7, 2011

(30) Foreign Application Priority Data
Jul. 10, 2008 (JP) 2008-180671
Feb. 27, 2009 (JP) 2009-046841

(51) Int. Cl. F27D 15/02

(52) U.S. Cl. 432/77

(57) ABSTRACT

A cooling chamber is provided which cools workpieces that have been heated. Cooling units are provided in the cooling chamber, and respectively include: a conveyor which simultaneously and uniserially conveys a plurality of workpieces; a mist cooling device which is disposed so as to surround the conveyance path of the conveyor and which supplies mist-like cooling liquid; and a gas cooling device which is disposed so as to surround the conveyance path of the conveyor and which supplies cooling gas.

### TECHNICAL FIELD

The present invention relates to a heat treatment apparatus. For example, it relates to a heat treatment apparatus that is suitable for use in quenching and the like of workpieces. Priority is claimed on Japanese Patent Application No. 2008-180671, filed Jul. 10, 2008, and Japanese Patent Application No. 2009-046841, filed Feb. 27, 2009, the content of which is incorporated herein by reference.

### BACKGROUND ART

In cases where high-speed cooling is required in a heat treatment apparatus which conducts treatment such as so-called quenching by heating and cooling of metal material that is the subject of treatment, cooling apparatuses using an oil cooling system or cooling apparatuses using a gas cooling system have previously been employed. With respect to the aforementioned cooling apparatuses using an oil cooling system, cooling efficiency is excellent, but there is the problem that precise cooling control is almost impossible, and that the articles subjected to heat treatment tend to deform. On the other hand, with respect to cooling apparatuses using a gas cooling system, cooling control is facilitated by control of the gas flow rate, and excellent results are obtained with respect to deformation of articles subjected to heat treatment, but there is the problem that cooling efficiency is low.

Thus, in Patent Document 1, a technology is disclosed which seeks improved cooling controllability and cooling efficiency by disposing liquid nozzles and gas nozzles around the articles subjected to heat treatment, supplying cooling liquid from the liquid nozzles by a spray method, and supplying cooling gas from the gas nozzles.

### PRIOR ART LITERATURE

### Patent Literature

Patent Document 1: Japanese Unexamined Patent Application, First Publication No. H11-153386

### SUMMARY OF THE INVENTION

### Problems that the Invention is to Solve

However, the following problems exist with the aforementioned prior art.

In the case where cooling is collectively performed with respect to multiple articles of heat treatment, it is difficult to uniformly conduct cooling, and irregularities in cooling may occur. Specifically, with respect to the articles of heat treatment, there is the problem that surfaces that facilitate supply of cooling liquid and surfaces that inhibit its supply tend to occur, and that temperature distributions arise even if cooling is performed, which constitute one factor in deformation of articles of heat treatment.

The present invention was made in light of the foregoing circumstances, and its object is to offer a heat treatment apparatus that enables strain and deformation of workpieces to be sufficiently minimized.

### Means for Solving the Problems

In order to achieve the aforementioned objective, the present invention adopts the following configuration.

The heat treatment apparatus of the present invention is a heat treatment apparatus which is provided with a cooling chamber for cooling of workpieces that have been heated, wherein a cooling unit which is provided in the aforementioned cooling chamber includes: a conveyor that simultaneously and uniserially conveys the aforementioned multiple workpieces; a mist cooling device that is disposed so as to surround the conveyance path of the aforementioned conveyor, and that supplies a mist-like cooling liquid; and a gas cooling device that is disposed so as to surround the conveyance path of the aforementioned conveyor, and that supplies cooling gas.

Accordingly, with the heat treatment apparatus of the present invention, it is possible to inhibit the formation of vapor film on the surfaces of workpieces by regulating the supply volume of mist-like cooling liquid to the workpieces on the conveyance path. Furthermore, using the latent heat of vaporization, it is possible to cool workpieces with high cooling efficiency. Moreover, the workpieces can be cooled with a high degree of controllability by adjusting supply volume according to the cooling efficiency of the workpieces. As the workpieces to be cooled are conveyed in a single row, when the mist-like cooling liquid is supplied by the mist cooling device that is disposed around the periphery, the cooling liquid is uniformly supplied to the entirety of the treatment subject without occurrence of locations where the supply of cooling liquid is inhibited due to sheltering by another treatment subject. Consequently, with the present invention, it is possible to uniformly cool workpieces, and suppress the strain and deformation of workpieces that occur due to temperature distribution and the like.

With respect to the aforementioned cooling unit, one may suitably adopt a configuration wherein a plurality of cooling units is provided in parallel.

By this means, it becomes possible with the present invention to conduct cooling of workpieces in parallel while suppressing strain and deformation of the workpieces, thereby enabling contribution to enhanced productivity.

In the foregoing case, one may suitably adopt a configuration wherein the aforementioned plurality of cooling units is arranged within the same cooling chamber.

In the case where a cooling chamber is provided for each cooling unit, the size of the apparatus is enlarged. However, with the present invention, it is possible to suppress enlargement of the cooling chamber even in the case where workpieces are cooled in parallel.

In addition, with respect to the aforementioned heat treatment apparatus, one may suitably adopt a configuration wherein the aforementioned mist cooling device supplies the aforementioned cooling liquid from positions which are mutually separated along the aforementioned conveyance path.

By this means, the present invention enables reliable supply of cooling liquid to the entirety of the treatment subject, and enables uniform cooling treatment to be more reliably conducted with respect to workpieces.

Moreover, with respect to the aforementioned heat treatment apparatus, one may suitably adopt a configuration wherein the aforementioned mist cooling device has tubular bodies that are provided so as to extend along the aforementioned conveyance path and that supply the aforementioned cooling liquid, and nozzles that are provided in the aforementioned tubular bodies in a mutually separated manner along the aforementioned conveyance path.

By this means, the present invention enables the cooling liquid that is supplied to the tubular bodies to be uniformly sprayed in a mist, and enables cooling to be uniformly conducted with respect to the entirety of the treatment subject.

Furthermore, with respect to the aforementioned heat treatment apparatus, one may suitably adopt a configuration wherein the aforementioned tubular bodies are multiply disposed at approximately equal intervals in the circumferential direction centering on the aforementioned conveyance path.

By this means, the present invention enables cooling liquid to be evenly supplied in a mist from the periphery of the treatment subject, and enables uniform cooling treatment to be conducted without occurrence of temperature distribution. When arranging the aforementioned tubular bodies, uniformity is further increased by conducting the arrangement taking into consideration the gravity that is sustained by the sprayed mist.

Moreover, with respect to the heat treatment apparatus of the present invention, one may suitably adopt a configuration which has a gauge that measures the temperature of the aforementioned workpieces, and a control device that controls the supply volume of the aforementioned cooling liquid based on the measurement results of the aforementioned gauge.

By this means, it is possible to provide the optimal supply volume of cooling liquid according to the temperature of workpieces.

In addition, with respect to the aforementioned heat treatment apparatus, one may suitably adopt a configuration wherein the aforementioned gauge measures the temperatures of the aforementioned workpieces at positions that respectively correspond to the aforementioned mist cooling devices that are multiply provided, and the aforementioned control device individually controls the supply volumes of the aforementioned cooling liquid of the aforementioned multiple mist cooling devices, based on the aforementioned measurement results.

By this means, the present invention enables individual control of the supply volumes of cooling liquid from the mist cooling devices according to the temperature distribution of the treatment subject at positions corresponding to the mist cooling devices in order to negate this temperature distribution, and enables control of the temperature of workpieces with high precision.

Furthermore, the heat treatment apparatus of the present invention has a press device that presses the aforementioned workpieces from prescribed directions.

By this means, even in cases where there are fluctuations in the heat transfer coefficient of workpieces during cooling, the present invention enables minimization of strain and deformation of workpieces by forcibly pressing the workpieces.

Moreover, with the present invention, one may suitably adopt a configuration wherein the aforementioned cooling liquid is an inert fluoroliquid.

By this means, it is possible with the present invention to prevent the cooling liquid from exercising a negative influence on workpieces, and prevent the surface oxidation that occurs with water-cooling systems.

### EFFECTS OF THE INVENTION

The present invention enables cooling of workpieces with a high degree of controllability, while sufficiently minimizing strain and deformation of workpieces.

### BRIEF DESCRIPTION OF THE DRAWINGS

FIG. 1 is an overall configuration diagram of the vacuum heat treatment furnace pertaining to the present embodiment.

FIG. 2 is a front sectional view pertaining to a cooling chamber 160.

FIG. 3 is a sectional view along line A-A of FIG. 2.

FIG. 4 is a drawing which shows a second embodiment of the heat treatment apparatus.

FIG. 5 is a sectional view of the cooling chamber pertaining to the third embodiment.

FIG. 6 is a sectional view of the cooling chamber pertaining to the third embodiment.

### BEST MODE FOR CARRYING OUT THE INVENTION

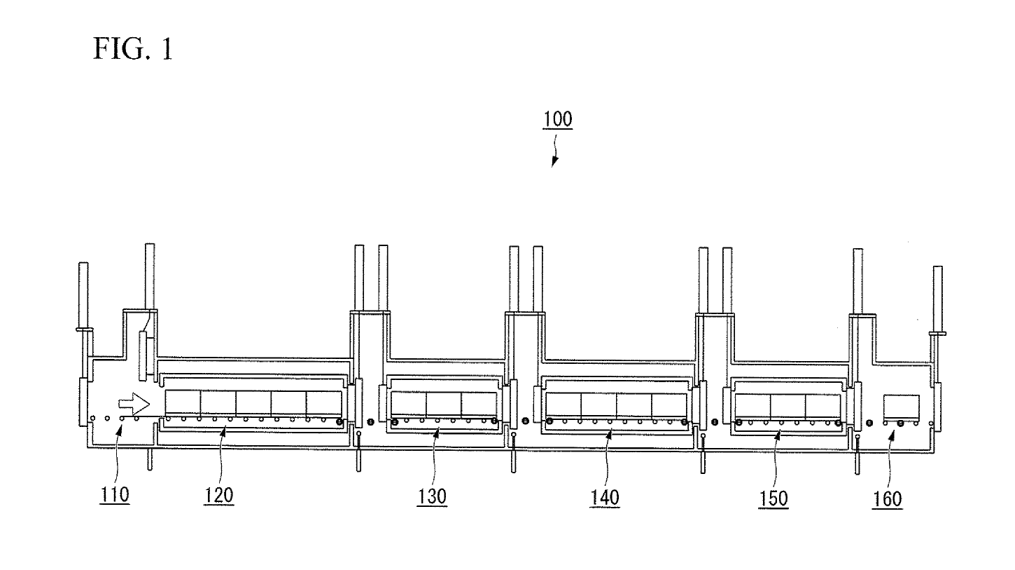

Below, embodiments of the heat treatment apparatus of the present invention are described with reference to FIG. 1 to FIG. 6.

It should be noted that in each of the drawings used in the following description, the dimensions of each component have been appropriately altered so as to render each component in a size that is easily comprehensible.

Moreover, with respect to the heat treatment apparatus of the present embodiments, the case of a multi-chamber type vacuum heat treatment furnace (hereinafter simply “vacuum heat treatment furnace”) is shown.

### First Embodiment

FIG. 1 is an overall configuration diagram of the vacuum heat treatment furnace of the present embodiment.

A vacuum heat treatment furnace (heat treatment apparatus) 100 conducts heat treatment of workpieces, and has a configuration wherein a deaerating chamber 110, a pre-heating chamber 120, a carburizing chamber 130, a diffusion chamber 140, a temperature reduction chamber 150, and a cooling chamber 160 are arranged in a consecutively adjacent manner, and workpieces are sequentially and uniserially conveyed to each chamber 110-160.

As the present invention is characterized by the configuration of the cooling chamber 160, the cooling chamber 160 is described below in detail.

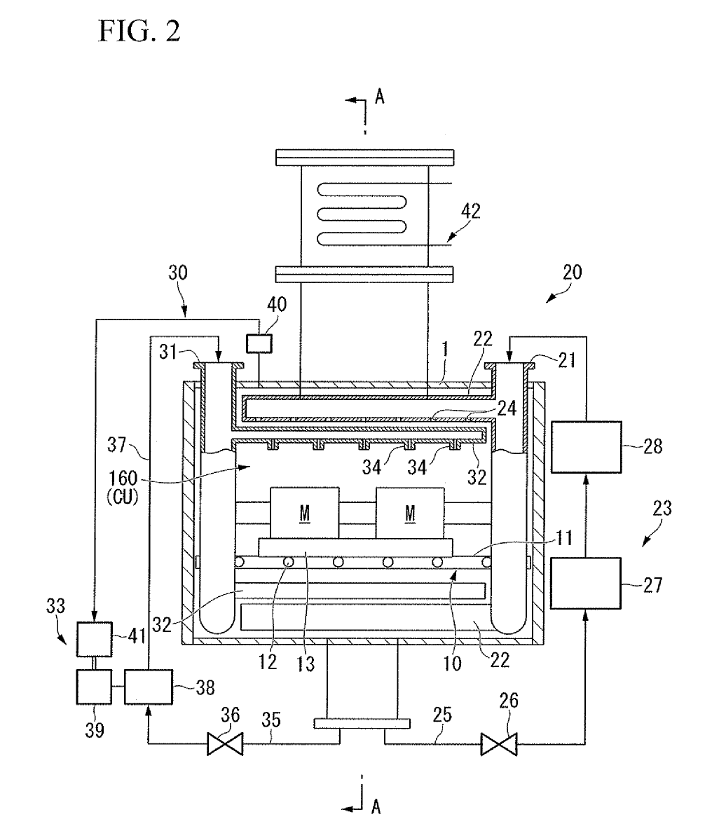

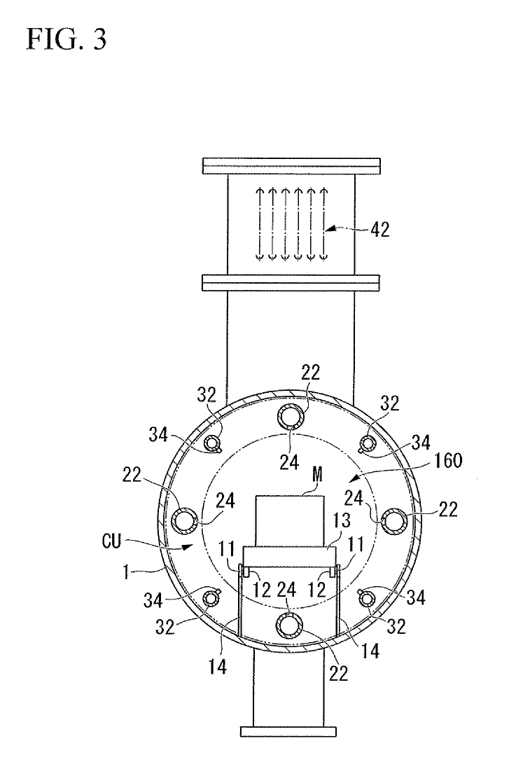

FIG. 2 is a front sectional view of the cooling chamber 160, and FIG. 3 is a sectional view along line A-A of FIG. 2. The cooling chamber 160 is formed within a vacuum container 1. Moreover, within the vacuum container 1, a cooling unit CU is provided that is composed of a conveyor 10, a gas cooling device 20, and a mist cooling device 30.

The conveyor 10 is capable of uniserially and simultaneously conveying multiple workpieces M in a horizontal direction. It also has a pair of support frames 11 which are arranged in mutual opposition with an interval in between and which extend in the conveyance direction (horizontal direction), rollers 12 which are provided so as to be capable of rotating on the opposed surfaces of the respective support frames 11 with a prescribed separation in the conveyance direction, a tray 13 on which the workpieces M are placed and which is conveyed on the rollers 12, and support frames 14 (not illustrated in FIG. 2) which are provided in the vertical direction and which support the two ends of the support frames 11.

It should be noted that the conveyance direction of the workpieces M of the conveyor 10 is simply referred to as “the conveyance direction” in the following description.

The tray 13 is, for example, formed into an approximately rectangular parallelepiped by a grid-like arrangement of wires. Its width is somewhat larger than the width of a treatment subject M, and is formed to a size that is supported by the rollers 12 at the edges of the bottom face in the widthwise direction. The length of the tray 13 is in this instance formed to a size which allows placement of two workpieces M in the conveyance direction with an interval in between. Accordingly, in the present embodiment, it is possible to uniserially and simultaneously convey multiple (in this instance, two) workpieces M via this tray 13.

The gas cooling device 20 cools the workpieces M by supplying cooling gas to the interior of the cooling chamber 160. The gas cooling device 20 is provided with a header tube 21, supply tubes 22, and a gas recovery/supply system 23. As shown by the double-dotted lines in FIG. 3, the header tube 21 is disposed at the downstream end of the cooling chamber 160 in the conveyance direction, and is formed in an annular shape centering on the conveyance path of the workpieces M of the conveyor 10. Cooling gas is supplied to this header tube 21 by the gas recovery/supply system 23.

The supply tube 22 is formed so that one end is connected to the header tube 21, while the other end side extends horizontally toward the upstream side of the conveyance direction. Multiple (in this instance, four) supply tubes 22 are provided at approximately equal intervals (in this instance, 90° intervals) in the circumferential direction centering on the conveyance path of the workpieces M of the conveyor 10. Specifically, as shown in FIG. 3, the supply tubes 22 are provided at the 3 o'clock, 6 o'clock, 9 o'clock, and 12 o'clock positions (the left, right, top and bottom positions) of the annular header tube 21. Each supply tube 22 is formed so that its other end side extends horizontally toward the upstream side of the conveyance direction of the cooling chamber 160 with a length that corresponds to the length of the cooling chamber 160. In each supply tube 22, multiple spray ports 24 that open onto the conveyance path of the workpieces are formed along the entire lengthwise direction with a prescribed interval respectively.

The gas recovery/supply system 23 is primarily composed of an exhaust tube 25 that is connected to the vacuum container 1, an on/off valve 26 that is provided in the exhaust tube 25, a heat exchanger 27 that serves as a cooler for re-cooling cooling gas recovered by the exhaust tube 25, and a fan 28 that supplies cooling gas that has been re-cooled to the header tube 21.

As cooling gas, one may use, for example, inert gas such as argon, helium and nitrogen, or the like.

The mist cooling device 30 cools the workpieces M by supplying cooling liquid in the form of mist to the interior of the cooling chamber 160. The mist cooling device 30 is provided with a header tube 31 (not illustrated in FIG. 3), supply tubes (tubular bodies) 32, and a cooling liquid recovery/supply system 33. The header tube 31 is disposed at the upstream end of the cooling chamber 160 in the conveyance direction, and is formed in an annular shape centering on the conveyance path of the workpieces M of the conveyor 10. Cooling liquid is supplied to this header tube 31 by the cooling liquid recovery/supply system 33.

The supply tube 32 is formed so that one end is connected to the header tube 31, while the other end side extends horizontally toward the downstream side of the conveyance direction. Multiple (in this instance, four) supply tubes 32 are provided at approximately equal intervals (in this instance, 90° intervals) in the circumferential direction centering on the conveyance path of the workpieces M of the conveyor 10. Specifically, as shown in FIG. 3, the supply tubes 32 are provided at ±45° positions relative to the horizontal direction of the annular header tube 21. Each supply tube 32 is formed so that its other end side extends horizontally toward the downstream side of the conveyance direction of the cooling chamber 160 with a length that corresponds to the length of the cooling chamber 160. In each supply tube 32, multiple nozzles 34 that spray cooling liquid in the form of mist toward the conveyance path of the workpieces are formed along the entire lengthwise direction with a prescribed interval respectively.

With respect to the arrangement of the supply tubes 32 and the nozzles 34, as the mist-like cooling liquid is affected by gravity, it is preferable to supply the mist-like cooling liquid in the horizontal direction, and to avoid the vertical direction which may cause variations in supplied amount. However, in the case where cooling liquid is supplied in the vertical direction, it is sufficient to supply the cooling liquid in varying quantities taking into account the effects of gravity. In the case where less than four—for example, three—supply tubes 32 are arranged, it is preferable to conduct arrangement at the position of the apex and at positions of ±120° that sandwich this apex in order to minimize vertical components to the utmost.

The cooling liquid recovery/supply system 33 is principally composed of a drainage tube 35 that is connected to the vacuum container 1, an on/off valve 36 that is provided in the drainage tube 35, a pump 38, a sensor 40, an inverter 41, and a liquefier (liquefaction trap) 42. The pump 38 feeds the cooling liquid recovered by the drainage tube 35 to the header tube 31 via a pipe 37 by the driving of a motor 39. The sensor 40 measures the pressure (air pressure) of the cooling chamber 160. The inverter 41 is a liquid volume regulator that controls the driving of the motor 39 based on the measurement results of the sensor 40. The liquefier 42 liquefies cooling liquid that is vaporized by receiving heat from the treated articles.

As cooling liquid, one may use, for example, oil, salt, the below-mentioned inert fluoroliquids, or the like.

Next, a description is given of the procedure whereby heated workpieces M are cooled by the cooling chamber 160 in the aforementioned vacuum heat treatment furnace 100.

As shown in FIG. 2 and FIG. 3, the workpieces M are uniserially placed with separation in the conveyance direction on the tray 13, and conveyed to the cooling chamber 160.

The cooling liquid is supplied/sprayed in mist form from the nozzles 34 in the mist cooling device 30 to the workpieces M that are conveyed to the cooling chamber 160. In this instance, it is possible to spray the entirety of the side surfaces (outer circumferential surfaces) of the treatment subject M by setting the diffusion angle from the nozzles 34 at 90°, as shown, for example, in FIG. 3. At this time, as the tray 13 is formed by a grid-like arrangement of wires, the cooling liquid sprayed from the nozzles 34 that are positioned diagonally downward relative to the treatment subject M (tray 13) transits the gaps in the wire, reaches the treatment subject M without hindrance, and cools the treatment subject M. With respect to both the front and back surfaces of the treatment subject M in the conveyance direction, as the nozzles 34 are provided across the entire lengthwise direction of the cooling chamber 160, mist-like cooling liquid is supplied in particular by spraying from the nozzles 34 that are positioned at the two end sides of the supply tube 32. Consequently, the workpieces M can be cooled without difficulty.

With respect to the supply of the aforementioned mist-like cooling liquid, it is preferable to conduct treatment at or below atmospheric pressure from the standpoint of preventing leakage of cooling liquid from the vacuum container 1 during treatment. As to the physical values of the cooling liquid, in the case of an ambient temperature of 25° C. under atmospheric pressure, it is preferable to have a boiling point that is equal to or above that of water (a boiling point of 100° C. or more). This is because the temperature of the cooling liquid that is sprayed as mist increases due to heat exchange with the treatment subject M, because a heat exchanger is used as the structure (liquefier 42) to cool this, and because water is ordinarily used as the heat exchange medium.

In greater detail, with respect to the water of the heat exchange medium, a configuration wherein cooling is conducted with use of a cooling tower is common, and when the heat exchange rate with the cooling liquid is taken into account, it is appropriate to conduct use at 40-50° C. (i.e., use is conducted with a cooling liquid temperature after heat exchange (supply temperature of the mist-like cooling liquid) of 40-50° C.). Moreover, as the cooling liquid absorbs heat in a thermal volume corresponding to the difference between its boiling point and the temperature of the treatment subject M, it is preferable to have a boiling point with a temperature that is 30-50° C. higher than the supply temperature of the mist-like cooling liquid so as to enable absorption of a greater volume of heat. From the foregoing, with respect to the boiling point of the cooling liquid, a boiling point that is equal to or greater than that of water (a boiling point of 100° C. or greater) is desirable.

Specifically, for example, in the case where inert fluoroliquid with a boiling point of 131° C. is used at a normal temperature of 25° C. under atmospheric pressure (101 kPa (abs)), it is preferable to conduct treatment under conditions ranging from a controlled ambient pressure of 20 kPa (abs) with a boiling point of 80° C. to a controlled ambient pressure of 55 kPa (abs) with a boiling point of 110° C.

Meanwhile, cooling gas is supplied/sprayed from the spray ports 24 in the gas cooling device 20 to the workpieces M. The workpieces M are directly cooled by the sprayed cooling gas. Furthermore, it is possible to create a uniform atmosphere in the cooling chamber 160 by dispersing the cooling liquid that is sprayed in mist form into the cooling chamber 160 by the flow of the cooling gas.

In the case of cooling which uses this mist-like cooling liquid, the cooling liquid can be continuously supplied to enable heat exchange with the workpieces M. Consequently, there is no decline in cooling efficiency due to a reduction in contact area with the cooling liquid from bubbles generated by boiling of cooling liquid that contacts the high-temperature workpieces M, as in the case where the workpieces M are immersed in cooling liquid. Furthermore, there is also no increase in the amount of bubbles that would constitute a vapor film and form a heat insulating layer, resulting in a marked reduction of cooling efficiency. Accordingly, cooling treatment of the heat workpieces M can be continuously conducted.

The cooling liquid that is supplied in mist form to the cooling chamber 160 is liquefied by the inner wall surface of the vacuum container 1 and the liquefier 42, and accumulates at the bottom of the vacuum container 1. The motor 39 is driven and the pump 38 is actuated in a state where the on/off valve 26 in the gas recovery/supply system 23 is closed and the on/off valve 36 in the cooling liquid recovery/supply system 33 is open, whereby the accumulated cooling liquid is supplied so as to circulate through the header tube 31 via the pipe 37. Specifically, in the case where the sensor 40 detects that air pressure inside the cooling chamber 160 has decreased, and that the supply/injection volume of cooling liquid has decreased, the driving of the motor 39 is controlled by the inverter 41, and the supply volume of cooling liquid is adjusted, whereby an appropriate amount of cooling liquid is constantly supplied to the header tube 31.

On the other hand, the cooling gas that is supplied to the cooling chamber 160 is also circulated, and reused.

Specifically, the on/off valve 36 in the cooling liquid recovery/supply system 33 is closed, and the on/off valve 26 in the gas recovery/supply system 23 is opened, whereby the cooling gas that is introduced into the exhaust tube 25 from the cooling chamber 160 is re-cooled by the heat exchanger 27, and is supplied so as to circulate through the header tube 21 by operation of the fan 28.

As described above, in the present embodiment, cooling liquid is supplied in mist form from the nozzles 34 disposed at the periphery of the conveyance path to the workpieces M that are simultaneously and uniserially conveyed. Accordingly, it is possible to uniformly supply cooling liquid to the surface of workpieces M, and sufficiently minimize the strain and deformation of workpieces M that arise when cooling is irregular. In particular, as the workpieces M are cooled in the present embodiment using mist-like cooling liquid, no vapor film or the like is generated on the surfaces of the workpieces M, the cooling properties of liquid with a high heat exchange rate are maintained, and the flow rate of the supplied cooling liquid is regulated, thereby enabling cooling of workpieces M with a high degree of controllability.

Consequently, when, for example, heat treatment such as quenching is conducted with respect to workpieces M of steel wire in the present embodiment, it is possible to conduct cooling under conditions where a hard and brittle pearlite structure is not formed in the steel material, and high-quality workpieces M are obtained.

As multiple nozzles 34 are disposed along the conveyance path in the present embodiment, it is possible to reliably supply cooling liquid to the entirety of the treatment subject M, and more reliably conduct uniform cooling treatment of the treatment subject. In addition, in the present embodiment, as multiple supply tubes 32 that have the nozzles 34 are disposed at approximately equal intervals in the circumferential direction centering on the conveyance path of the workpieces M, it is possible to conduct uniform cooling of the entirety of the treatment subject M.

As the cooling liquid in the foregoing embodiment, it is preferable to use inert fluoroliquid.

In the case where inert fluoroliquid is used, the compositional material of the treatment subject M is not affected, and the exercise of negative effects on the treatment subject M can be prevented. As inert fluoroliquid is non-combustible, safety can also be enhanced. Moreover, as inert fluoroliquid has a higher boiling point than that of water, its cooling potential is also higher, and it is also possible to suppress problems such as oxidation and vapor film that occur in cases where water is used. In addition, heat transfer capacity is excellent even from the standpoint of latent heat of vaporization, enabling the workpieces M to be efficiently cooled. Furthermore, as there is no need to conduct washing even if inert fluoroliquid adheres to the workpieces M, productivity can also be enhanced.

### Second Embodiment

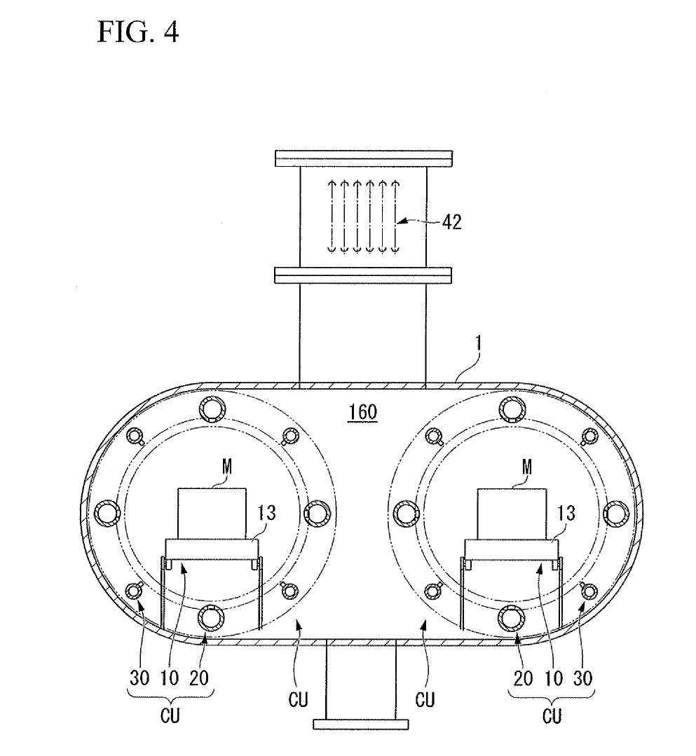

FIG. 4 is a drawing which shows a second embodiment of the heat treatment apparatus of the present invention.

In this drawing, components identical to components of the first embodiment shown in FIG. 1 to FIG. 3 are assigned the same reference numerals, and description thereof is omitted.

The second embodiment differs from the foregoing first embodiment in that cooling units CU are provided in parallel.

As shown in FIG. 4, in the present embodiment, cooling units CU are independently and separately provided in parallel in a direction approximately perpendicular to the conveyance direction of workpieces M in the same cooling chamber 160 that has an approximately elliptical shape from a cross-sectional viewpoint. Each cooling unit CU has a conveyor 10, a gas cooling device 20, and a mist cooling device 30, and is configured in the same manner as in the foregoing first embodiment.

In the present embodiment, as two cooling units CU are arranged in the same cooling chamber 160, not only is it possible to obtain the same actions and effects as the foregoing first embodiment, but also to achieve a more compact apparatus compared to the case where a cooling chamber is provided for each cooling unit CU.

Moreover, in the present embodiment, as each cooling unit CU cools workpieces M that are uniserially conveyed, there occur no locations where the supply of cooling liquid is inhibited due to sheltering by another treatment subject. Accordingly, it is possible to conduct cooling treatment with respect to multiple rows of workpieces while uniformly supplying cooling liquid to the entirety, and obtain high-quality workpieces with high productivity.

### Third Embodiment

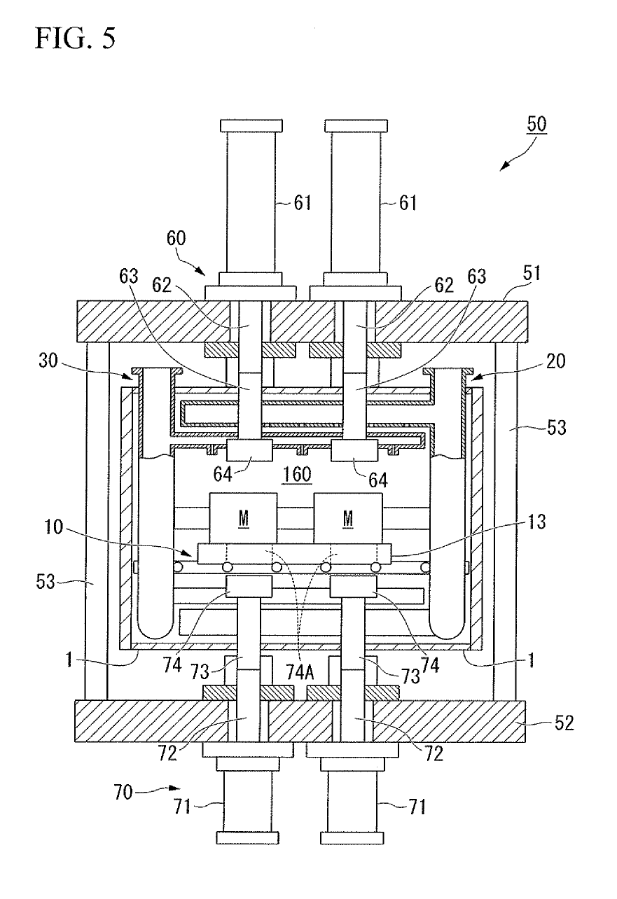

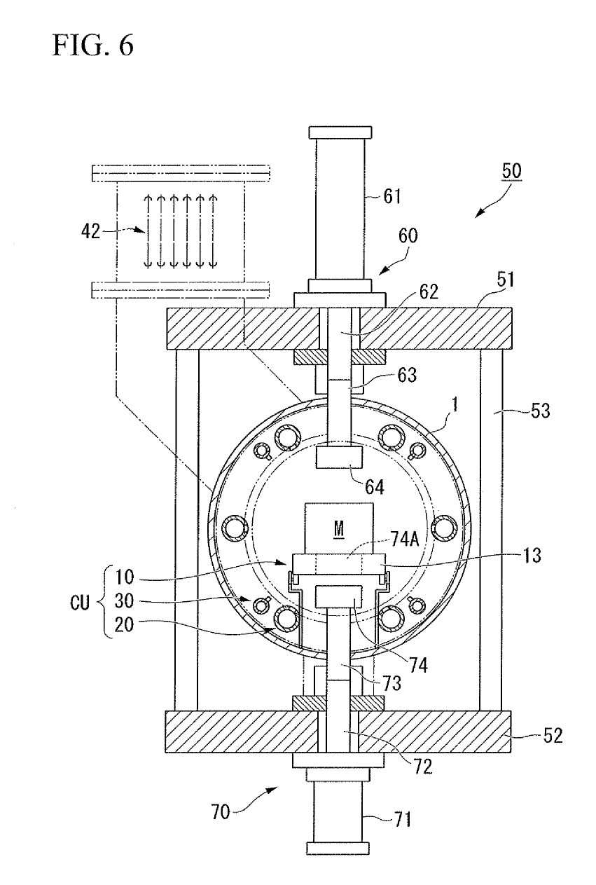

Next, a third embodiment is described with reference to FIG. 5 and FIG. 6.

In this drawing, components identical to components of the first embodiment shown in FIG. 1 to FIG. 3 are assigned the same reference numerals, and description thereof is omitted.

In the present embodiment, a press device is provided that presses the workpieces M.

As shown in FIG. 5 and FIG. 6, a press device 50 is principally configured from an upper press frame 51 and a lower press frame 52 that are provided so as to sandwich the vacuum container 1 and that are vertically supported on both sides by columns 53, columns 53 that are supported by the upper press frame and lower press frame, an upper press part 60 provided on the upper press frame 51, and a lower press part 70 provided on the lower press frame 52.

The upper press part 60 is provided with hydraulic cylinders 61, cylinder shafts 62, press rams 63, and upper punches 64. The hydraulic cylinders 61 are fixed onto the upper press frame 51. The cylinder shafts 62 are provided so as to freely move in the vertical direction in the hydraulic cylinders 61, and pass through the upper press frame 51. The upper punches 64 have surface shapes corresponding to the forms of the top faces of the workpieces M, and are provided so as to be removable from the press rams 63 by withdrawal of a joining pin (not illustrated in the drawings). The press rams 63 whose distal ends (upper punches 64) are disposed in the cooling chamber 160 are provided so as to pass through the outer wall of the vacuum container 1, and are joined to the distal ends of the cylinder shafts 62.

Similarly, the lower press part 70 is provided with hydraulic cylinders 71, cylinder shafts 72, press rams 73, and lower punches 74. The hydraulic cylinders 71 are fixed onto the lower press frame 52. The cylinder shafts 72 are provided so as to freely move in the vertical direction in the hydraulic cylinders 71, and pass through the lower press frame 52. The lower punches 74 have surface shapes corresponding to the forms of the bottom faces of the workpieces M, and are provided so as to be removable from the press rams 73 by withdrawal of a joining pin (not illustrated in the drawings). The press rams 73 whose distal ends (lower punches 74) are positioned in the cooling chamber 160 are provided so as to pass through the outer wall of the vacuum container 1, and are joined to the distal ends of the cylinder shafts 72.

Seal material such as O-rings are provided at the interfaces of the aforementioned hydraulic cylinders 61 and the upper press frame 51 and the lower press frame 52, and a configuration is adopted that maintains the vacuum environment of the cooling chamber 160.

As shown in FIG. 5, the upper press part 60 and lower press part 70 are mutually opposed, and are arranged so as to be separated in the conveyance direction at approximately the same pitch as the interval between the workpieces M that are uniserially placed on the tray 13. When the workpieces M are positioned at the cooling positions, through-holes 74A are formed along the movement paths of the lower punches 74 to enable passage of these lower punches 74.

In the foregoing configuration, when the tray 13 is conveyed by the conveyor 10 and when the uniserially disposed workpieces M are positioned at the cooling positions, the hydraulic cylinders 61 in the upper press part 60 are actuated, the cylinder shafts 62 and press rams 63 are lowered, and the upper punches 64 press the top faces of the workpieces M. Meanwhile, in synchronization with the operation of the upper press part 60, the hydraulic cylinders 71 in the lower press part 70 are actuated, the cylinder shafts 72 and press rams 73 are raised, and the upper punches 74 are raised through the through-holes 74A of the tray 13, and press the bottom faces of the workpieces M. By this means, the workpieces M are sandwiched between the upper punches 64 and lower punches 74 at their top faces and bottom faces.

In this manner, the above-described cooling treatment is conducted with respect to the workpieces M in a state where they are sandwiched and held between the upper punches 64 and lower punches 74.

In the present embodiment, as cooling is conducted while imparting pressing force to the workpieces M at the time when the workpieces M are cooled, not only it is possible to obtain the same actions and effects as the aforementioned first embodiment, but it is also possible to sufficiently minimize strain and deformation of the workpieces M.

With respect also to the second embodiment, it goes without saying that a press device 50 can be provided and that cooling can be conducted while pressing the workpieces M, as in the third embodiment.

While preferred embodiments of the invention have been described and illustrated above, it should be understood that these are exemplary of the invention, and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the foregoing embodiments adopted a configuration wherein two workpieces M are uniserially conveyed by the tray 13, but one is not limited thereto, and it is also acceptable to have a configuration wherein workpieces M are conveyed in a plurality of three or more.

Moreover, in the aforementioned second embodiment, the configuration was adopted wherein two cooling units CU were arranged in parallel in the same cooling chamber 160, but it is also acceptable to have a configuration wherein parallel arrangement is conducted in three or more rows.

In the foregoing embodiments, in order to control the temperature of the workpieces M with higher precision, it is also acceptable to adopt a configuration wherein, for example, gauges such as radiation thermometers are disposed within the cooling chamber 160 to measure the temperature of the workpieces M, and the inverter 41 that serves as the control device controls the supply volume of the mist-like cooling liquid according to the measured temperature.

Furthermore, in this case, it is also acceptable to adopt a configuration that not only provides gauges for measuring the temperature of the workpieces M at positions corresponding to each of the multiple nozzles 34, but that also provides an on/off valve in each nozzle 34, and controls the supply volume of mist-like cooling liquid of each nozzle based on the measurement results at each position.

By this means, it is possible to control the temperature of the workpieces M at each position corresponding to the nozzles 34, more uniformly cool the workpieces M, and suppress strain and deformation.

The supply of cooling liquid described in the foregoing embodiments is ordinarily conducted in a vacuum, and one may also adopt a configuration wherein, for example, the aforementioned inert gas is added during the mist cooling.

Ordinarily, when ambient pressure is high, the boiling point increases, and when ambient pressure is low, the boiling point decreases. Consequently, by adjusting the additive amount of inert gas and by raising ambient pressure, it is possible to suppress cooling capacity according to the latent heat of vaporization of the cooling liquid. Conversely, by lowering ambient pressure, it is possible to decrease the boiling point, widen the temperature differential with the workpieces M, and raise cooling speed (cooling capacity).

In this manner, by adjusting the additive amount of inert gas, it becomes possible to control the cooling properties of the workpieces M, and perform cooling with greater precision.

In the foregoing embodiments, oil, salt, inert fluoroliquid, etc. were enumerated as cooling liquids. In addition, one may also use water in cases where the effects of oxidation, vapor film and the like are minor. In the case where water is used as the mist-like cooling liquid, for reasons similar to the case where the aforementioned inert fluoroliquid is used, it is preferable to conduct treatment under conditions ranging from a controlled ambient pressure of 70 kPa (abs) with a boiling point of 90° C. to a controlled ambient pressure of 48 kPa (abs) with a boiling point of 80° C.

In the case where water is used as the cooling liquid, whether in a liquid phase or gaseous phase, drainage can be safely conducted without the need for complex after-treatment, which is ideal from the cost standpoint pertaining to after-treatment and the perspective of global environmental protection.

### INDUSTRIAL APPLICABILITY

With the present invention, it is possible to cool workpieces with a high degree of controllability, while sufficiently minimizing stress and deformation of workpieces.

### DESCRIPTION OF THE REFERENCE NUMERALS

10: conveyor
20: gas cooling device
30: mist cooling device
32: supply tube (tubular body)
34: nozzle
50: press device
100: vacuum heat treatment furnace (heat treatment apparatus)
160: cooling chamber
CU: cooling unit

1. A heat treatment apparatus which is provided with a cooling chamber for cooling of workpieces that have been heated, comprising:
a cooling unit which is provided in the cooling chamber and which respectively comprise: a conveyor that simultaneously and uniserially conveys a plurality of the workpieces;
a mist cooling device that is disposed so as to surround the conveyance path of the conveyor, and that supplies a mist-like cooling liquid;
and a gas cooling device that is disposed so as to surround the conveyance path of the conveyor, and that supplies cooling gas.

2. The heat treatment apparatus according to claim 1, wherein a plurality of the cooling unit is provided in parallel.

3. The heat treatment apparatus according to claim 2, wherein the plurality of cooling units is arranged within the same cooling chamber.

4. The heat treatment apparatus according to claim 1, wherein the mist cooling device supplies the cooling liquid from positions which are mutually separated along the conveyance path.

5. The heat treatment apparatus according to claim 4, wherein the mist cooling device has a tubular body that is provided so as to extend along the conveyance path and that supplies the cooling liquid, and nozzles that are provided in the tubular body in a mutually separated manner along the conveyance path.

6. The heat treatment apparatus according to claim 5, wherein a plurality of the tubular bodies is multiply disposed at approximately equal intervals in the circumferential direction centering on the conveyance path.

7. The heat treatment apparatus according to claim 1, which has a gauge that measures the temperature of the workpieces, and a control device that controls the supply volume of the cooling liquid based on the measurement results of the gauge.

8. The heat treatment apparatus according to claim 7, wherein:
the gauge measures the temperatures of the workpieces at positions that respectively correspond to the mist cooling devices that are multiply provided,
and the control device individually controls the supply volumes of the cooling liquid of the multiple mist cooling devices, based on the measurement results.

9. The heat treatment apparatus according to claim 1, which has a press device that presses the workpieces from prescribed directions.

10. The heat treatment apparatus according to claim 1, wherein the cooling liquid is an inert fluoroliquid.
